(19) United States
(12) Patent Application Publication
(10) Pub. No.: US 2026/0010261 A1
(43) Pub. Date: Jan. 8, 2026

(54) TOUCH CONTROL METHOD, TOUCH CONTROL CIRCUIT, AND TOUCH PANEL

(71) Applicant: JADARD TECHNOLOGY INC., Shenzhen (CN)

(72) Inventors: TUO-YU YAO, Hsinchu (TW); Yu-Chieh Hsu, Tainan (TW)

(21) Appl. No.: 19/218,835

(22) Filed: May 27, 2025

(30) Foreign Application Priority Data
Jul. 2, 2024 (CN) 202410882278.X

(51) Int. Cl. G06F 3/041; G06F 3/044

(52) U.S. Cl. CPC G06F 3/04182; G06F 3/04164; G06F 3/0447

(57) ABSTRACT

A touch control method applied to a touch panel including a plurality of driving electrodes and a plurality of sensing electrodes intersect to form a plurality of touch nodes. The touch control method includes: receiving a driving code matrix of 2n-1 order comprising a plurality of codes corresponding to the plurality of touch nodes; sending a plurality of driving signals to the plurality of driving electrodes simultaneously according to the driving code matrix; and receiving a sensing code matrix generated by the plurality of sensing electrodes based on the plurality of driving signals, wherein the sensing code matrix is configured to obtain a touch position. A computer-readable storage medium, a touch control circuit, and a touch panel are further provided.

### FIELD

The subject matter herein generally relates to a touch control method, a touch control circuit capable of reading the computer program from the computer-readable storage medium, and a touch panel including the touch control circuit.

### BACKGROUND

A multiple access scheme is adopted for modulating/demodulating touch signals to improve the Signal-to-Interference-plus-Noise Ratio (SINR, commonly referred to as the signal-to-noise ratio) of a touch panel.

A conventional multiple access method is to generate touch driving signals and receive touch sensing signals based on matrices such as the Hadamard matrix or Walsh-Hadamard matrix, which causes distortion in subsequent sampling of the touch sensing signals.

### BRIEF DESCRIPTION OF THE DRAWINGS

Implementations of the present disclosure will now be described, by way of embodiment, with reference to the attached figures, wherein:

FIG. 1 is a schematic structural diagram of a touch panel according to an embodiment of the present disclosure.

FIG. 2 is a flowchart of a touch control method according to an embodiment of the present disclosure.

FIG. 3 shows a driving code matrix according to an embodiment of the present disclosure.

FIG. 4 is a timing diagram of driving signal waveforms corresponding to the driving code matrix shown in FIG. 3.

FIG. 5 shows a driving code matrix according to another embodiment of the present disclosure.

FIG. 6 is a timing diagram of driving signal waveforms corresponding to the driving code matrix shown in FIG. 5.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

“Above” means one layer is on top of another layer. In one example, it means one layer is situated directly on top of another layer. In another example, it means one layer is situated over the second layer directly or indirectly with more layers or spacers in between.

When a feature or element is herein referred to as being “on” another feature or element, it can be directly on the other feature or element or intervening features and/or elements may also be present. It will also be understood that, when a feature or element is referred to as being “connected”, to another feature or element, it can be directly connected, attached, or coupled to the other feature or element or an intervening features or elements may be present.

The present embodiment provides a touch panel. The touch panel can be applied to various smart devices that require human-computer interaction, such as displays, smart home appliances, and terminal communication devices. When the touch panel is applied to the above-mentioned smart devices, it is used to receive touch operations (such as finger touch, stylus touch, etc.), so that the smart devices can activate corresponding functions in response to the touch operation.

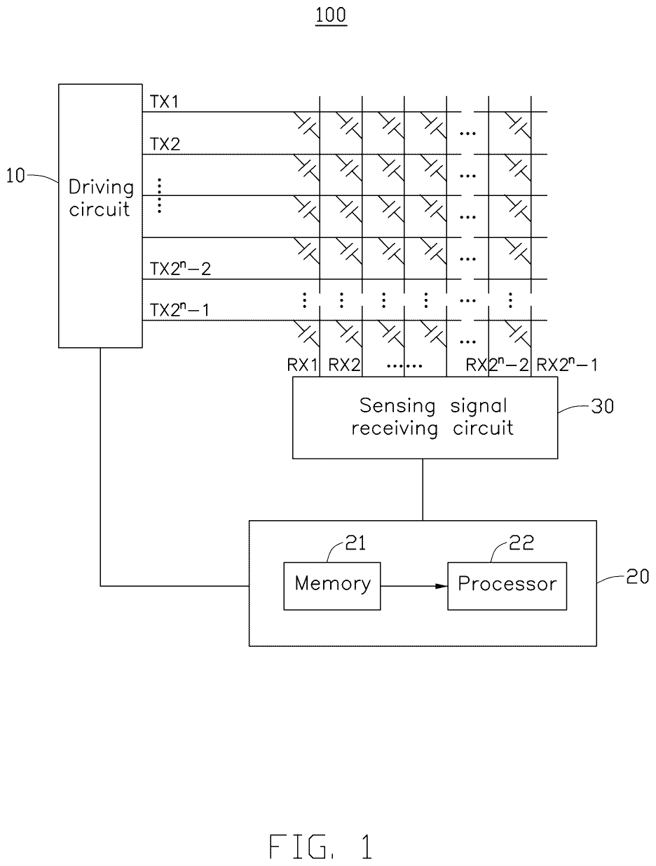

Referring to FIG. 1, the touch panel 100 of the present embodiment includes a plurality of driving electrodes, a plurality of sensing electrodes, a driving circuit 10, a touch control circuit 20 and a sensing signal receiving circuit 30. The plurality of driving electrodes are presented as TX1, TX2 . . . . TX2ⁿ-2 and TX2ⁿ-1, the plurality of sensing electrodes are presented as RX1, RX2 . . . . RX2ⁿ-2 and RX2ⁿ-1, and n is a positive integer greater than 1.

The driving circuit 10 is connected with the driving electrodes TX1, TX2 . . . . TX2ⁿ-2 and TX2ⁿ-1, respectively. The sensing signal receiving circuit 30 is connected with the sensing electrodes RX1, RX2 . . . . RX2ⁿ-2 and RX2ⁿ-1, respectively. The touch control circuit 20 is connected with the driving circuit 10 and the sensing signal receiving circuit 30.

Each driving electrode and each sensing electrode is a bar shaped electrode. Each driving electrode extends along a horizon direction, while each sensing electrode extends along a vertical direction. The driving electrodes TX1, TX2 . . . . TX2ⁿ-2 and TX2ⁿ-1 are parallel and spaced apart from each other, and the sensing electrodes RX1, RX2 . . . . RX2ⁿ-2 and RX2ⁿ-1 are parallel and spaced apart from each other. The driving electrodes are arranged along the vertical direction, and the sensing electrodes are arranged along the horizon direction. The driving electrodes interleaved with the sensing electrodes in a crossing arrangement to form a touch node at each intersection position, wherein the driving electrodes and the sensing electrodes form a touch node array.

The driving circuit 10 is used to simultaneously output a plurality of driving signals based on a driving code matrix. Each driving signal is sent to one of the driving electrodes TX1, TX2 . . . . TX2ⁿ-2 and TX2ⁿ-1, and the driving signals are sent to different sensing electrodes. The sensing electrodes RX1, RX2 . . . . RX2ⁿ-2 and RX2ⁿ-1 are used to generate sensing signals when the driving electrodes TX1, TX2 . . . . TX2ⁿ-2 and TX2ⁿ-1 receive the driving signals. The sensing signal receiving circuit 30 is used to receive the sensing signals from the sensing electrodes RX1, RX2 . . . . RX2ⁿ-2 and RX2ⁿ-1. The sensing signals form a sensing code matrix. The touch control circuit 20 is used to obtain a capacitance matrix based on the sensing code matrix and finally identify at least one touch position on the touch panel 100 based on the capacitance matrix. That is, the touch control circuit 20 is used to identify which touch node (or nodes) has received a touch operation.

In some conventional touch panels, a Hadamard matrix or a Walsh Hadamard matrix is used as a driving code matrix. However, a first row and a first column of the Hadamard matrix or the Walsh Hadamard matrix are all encoded as 1, which leads to excessive arithmetic sum of the first column code in the driving code matrix. Therefore, a sensing signal received by a first sensing electrode corresponding to the first column code of the driving code matrix has a large cumulative sum. An ADC (Analog to Digital Converter) is used to perform sampling, holding and quantization of the first sensing signal. According to a sampling principle of, the large cumulative sum may cause signal distortion during sampling, which results in a mismatch between a finally generated sensing signal and the driving signal, consequently degrading a signal-to-noise ratio (SNR) of a touch panel including the first sensing electrode.

The present embodiment also provides a touch control method applied to the touch panel 100, which is advantageous in solving the above problems and improving the signal-to-noise ratio of the touch panel 100 by improving the driving code matrix.

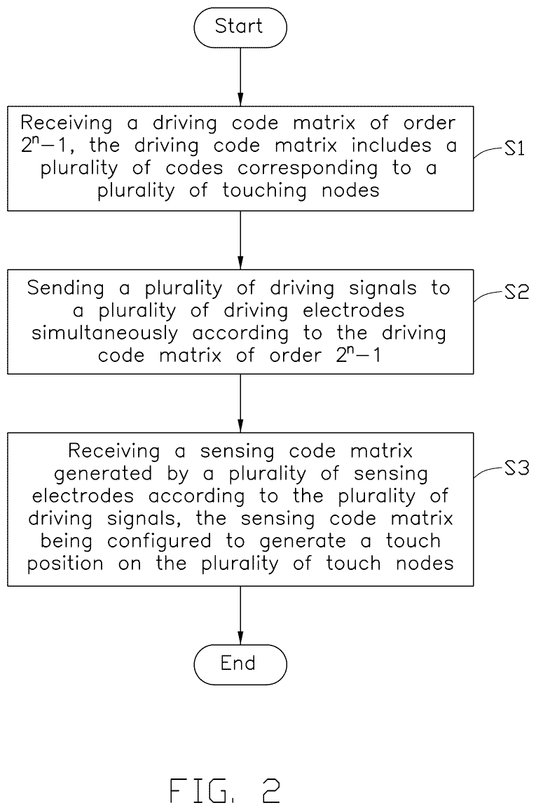

Referring to FIG. 2, the touch control method of the present embodiment includes:

S1, receiving a 2ⁿ-1 order driving code matrix including a plurality of codes corresponding to a plurality of touch nodes, wherein n is a positive integer greater than 1.

S2, sending a plurality of driving signals to a plurality of driving electrodes TX1, TX2 . . . . TX2ⁿ-2 and TX2ⁿ-1 simultaneously based on the driving code matrix.

S3, receiving a sensing code matrix generated by a plurality of sensing electrodes RX1, RX2 . . . . RX2ⁿ-2 and RX2ⁿ-1 based on the plurality of driving signals, the sensing code matrix being used to obtain touch positions on the plurality of touch nodes.

In block S1, the touch control circuit 20 receives the driving code matrix and generate the driving signals based on the driving code matrix. The driving code matrix is related to the Hadamard matrix and has an order of 2ⁿ-1.

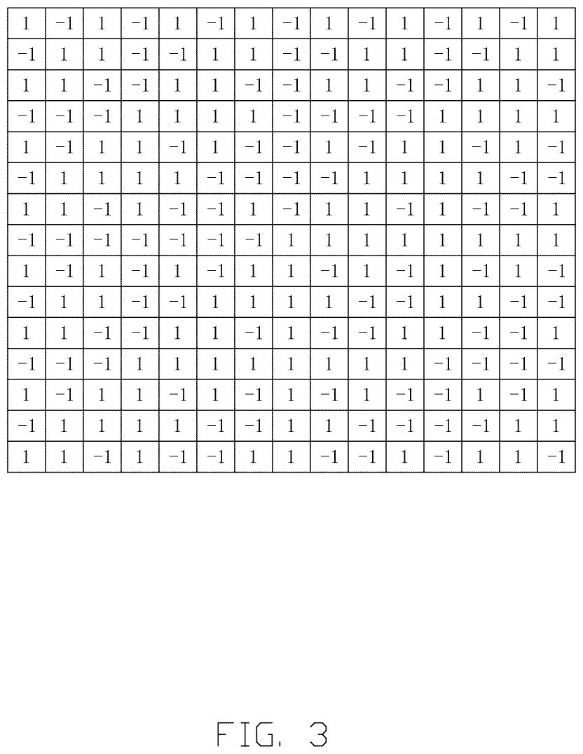

Referring to FIG. 3, in this embodiment, the driving code matrix is of 15th order. That is, the driving code matrix includes 15 rows and 15 columns of code, respectively.

In this embodiment, all codes in the driving code matrix are either 1 or −1. Each column of the driving code matrix includes multiple codes 1 and multiple codes −1. A code 1 represents sending a positive driving signal to a corresponding drive electrode, and a code −1 represents sending a negative driving signal to a corresponding drive electrode.

The arithmetic sums of codes in each column of the driving code matrix are equal. In at least one embodiment, the arithmetic sums of codes in each column of the driving code matrix are 1. That is, in the driving code matrix of this embodiment, each column includes 8 codes 1 and 7 codes −1, so that the arithmetic sum of the codes in each column is 1.

During a process of generating the sensing signals based on the driving signals, each sensing electrode is used to receive a total sensing signal, the total signal is obtained by summing the sensing signals from the touch nodes in a corresponding column (that is, touch nodes formed by the sensing electrode and the driving electrodes). In this embodiment, the total sensing signal is a stable-amplitude and low-amplitude signal since the arithmetic sums of codes in each column of the driving code matrix are 1. Therefore, according to the ADC sampling principle, a probability of sampling distortion is reduced and the signal-to-noise ratio of the touch panel 100 is improved. The smaller the arithmetic sums of codes in each column of the driving code matrix, the lower the probability of sampling distortion, the more stable of the total sensing signal received by each sensing electrode, and the higher the signal-to-noise ratio of the touch panel 100.

In block S2, the touch control method of the present embodiment adopts a multiple access method to simultaneously output the driving signals to the driving electrodes TX1, TX2 . . . . TX2ⁿ-2, TX2ⁿ-1.

In this embodiment, simultaneously sending the driving signals to the driving electrodes TX1, TX2 . . . . TX2ⁿ-2 and TX2ⁿ-1 includes: simultaneously sending positive driving signals (corresponding to code 1) to some of the driving electrodes and simultaneously sending negative driving signals (corresponding to code −1) to the remaining driving electrodes.

The touch panel 100 works during a plurality of touch cycles. During each touch cycle, simultaneously sending the driving signals to the driving electrodes during each touch cycle, receiving sensing signals generated on the sensing electrodes, and recognizing touch operations based on the sensing signals. A period during which the driving signals are output to the driving electrodes in each touch cycle is defined as a driving period T.

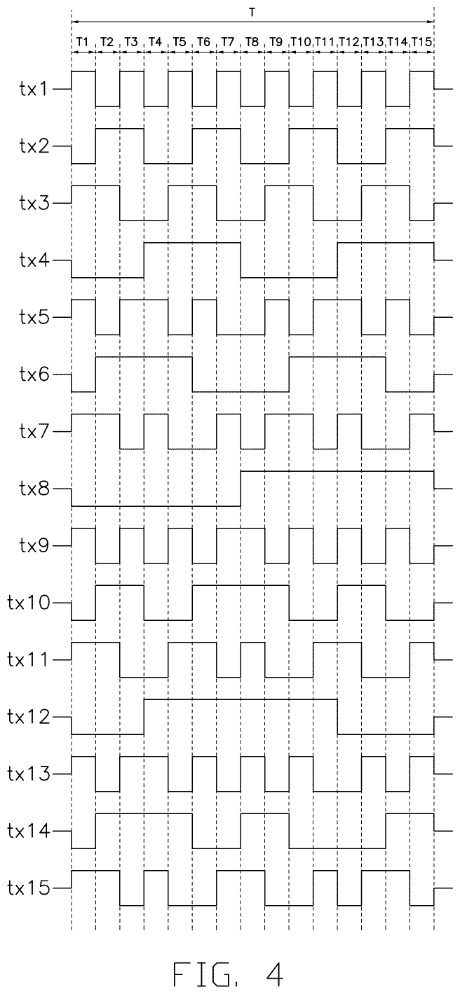

Referring to FIG. 4, in this embodiment, since the driving code matrix is a 15th order matrix, one driving period T includes 15 consecutive driving intervals, each of which has an equal duration.

In this embodiment, after receiving the driving code matrix, the driving circuit 10 generates the first to fifteenth driving signals tx1 to tx15. Each column of the driving code matrix corresponds to one driving signal, and the 15 columns of codes correspond to the first to fifteenth driving signals tx1 to tx15, respectively. Each row of the driving code matrix represents an output mode of one driving signal within one driving period, and the 15 rows correspond to the output modes in 15 driving period.

In each driving period, code 1 represents sending a positive driving signal to a corresponding drive electrode, and code −1 represents sending a negative driving signal to a corresponding drive electrode. The positive driving signal and the negative driving signal have a same amplitude.

The following takes the first, second, and third rows of the driving code matrix as an example for clarifying corresponding relationship between the driving code matrix and the driving signals.

The first row of the driving code matrix includes codes 1, −1, 1, −1, 1, −1, 1, −1, −1, −1, −1, −1, −1, −1, −1, from left to right. The first row of codes indicates that the first driving signal tx1 output to a first driving electrode TX1 is a positive pulse during a first driving period T1, a third driving period T3, a fifth driving period T5, a seventh driving period T7, a nineth driving period T9, a eleventh driving period T11, a thirteenth driving period T13, and a fifteenth driving period T15, while the first driving signal tx1 output to the first driving electrode TX1 is a negative pulse during a second driving period T2, a fourth driving period T4, a sixth second driving period T6, an eighth driving period T8, a tenth driving period T10, a twelfth driving period T12, and a fourteenth driving period T14.

The second row of the driving code matrix includes codes −1, 1, 1, −1, −1, 1, 1, −1, −1, 1, 1, −1, −1, 1, 1, from left to right. The second row of codes indicates that a second driving signal tx2 output to a second driving electrode TX2 is a negative pulse during the first driving period T1, the fourth driving period T4, the fifth driving period T5, the eighth driving period T8, the nineth driving period T9, the twelfth driving period T12, and the thirteenth driving period T13, while the second driving signal tx2 output to the second driving electrode TX2 is a positive pulse during the second driving period T2, the third driving period T3, the sixth second driving period T6, the seventh driving period T7, the tenth driving period T10, the eleventh driving period T11, the fourteenth driving period T14, and the fifteenth driving period T15.

The third row of the driving code matrix includes codes 1, 1, −1, −1, 1, 1, −1, −1, 1, 1, −1, −1, 1, 1, −1, from left to right. The third row of codes indicates that a third driving signal tx3 output to a third driving electrode TX3 is a positive pulse during the first driving period T1, the second driving period T2, the fifth driving period T5, the sixth second driving period T6, the nineth driving period T9, the tenth driving period T10, the thirteenth driving period T13, and the fourteenth driving period T14, while the third driving signal tx3 output to the driving electrode TX2 is a negative pulse during the third driving period T3, the fourth driving period T4, the seventh driving period T7, the eighth driving period T8, the eleventh driving period T11, the twelfth driving period T12, and the fifteenth driving period T15.

The fourth to fifteenth driving signals tx4 to tx15 are simultaneously output to the fourth to fifteenth driving electrodes TX4 to TX15, respectively, in a mode shown in FIG. 4. In this embodiment, a number of the driving electrodes is equal to the order of the driving code matrix. In other embodiments, the number of the driving electrodes may be less than the order of the driving code matrix and driving signals corresponding to some of the codes in the driving code matrix are output to the driving electrodes, each of the driving electrodes can receive one of the driving signals.

In this embodiment, the above-mentioned driving signals tx1, tx2 . . . tx2n-2, tx2n-1 are rectangular waves. In other embodiments, the driving signal may be sine waves, or triangular waves.

In block S3, when a touch operation occurs on one or more touch node, capacitance at the touch node(s) changes, causing the sensing signals received by the sensing electrodes RX1, RX2 . . . . RX2ⁿ-2 and RX2ⁿ-1 to change. The sensing signal receiving circuit 30 generates a sensing code matrix based on the sensing signals.

In the sensing code matrix, codes in one column represents sensing signals generated by all sensing electrodes within one driving period based on the driving signals on all driving electrodes, and codes in one row represents sensing signals generated by one sensing electrode within one driving cycle based on the driving signals on one driving electrode. That is, each code in the sensing code matrix is one sensing signal generated based on a corresponding driving signal on a corresponding driving electrode.

In this embodiment, after receiving the sensing code matrix generated by the sensing electrodes RX1, RX2 . . . . RX2ⁿ-2 and RX2ⁿ-1, the touch control method further includes: touch the control circuit 20 multiplying the sensing code matrix with a preset demodulation matrix to obtain a capacitance matrix and identifying the touch position based on the capacitance matrix, wherein the preset demodulation matrix is obtained by changing all codes −1 of the sensing code matrix into 0.

In this embodiment, each code in the capacitance matrix represents one capacitance value. That is, the sensing signals are converted into capacitance values. The touch position can be identified based on capacitance changes at corresponding one or more touch node(s).

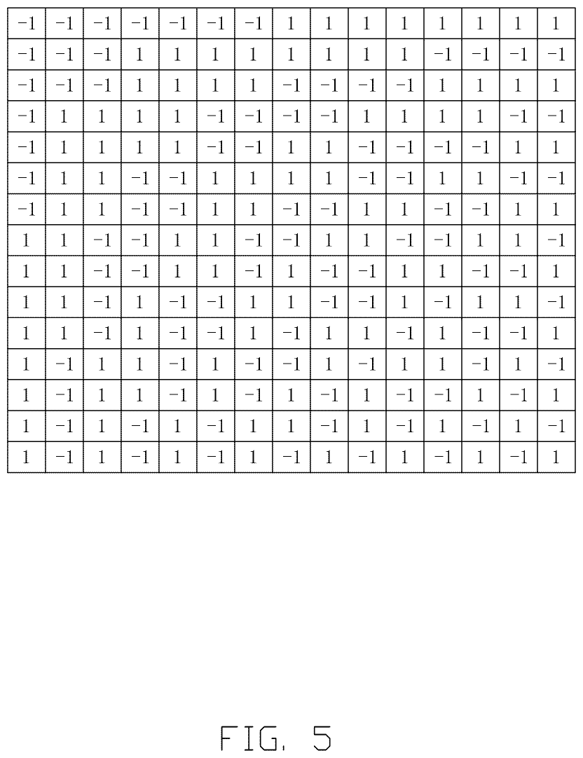

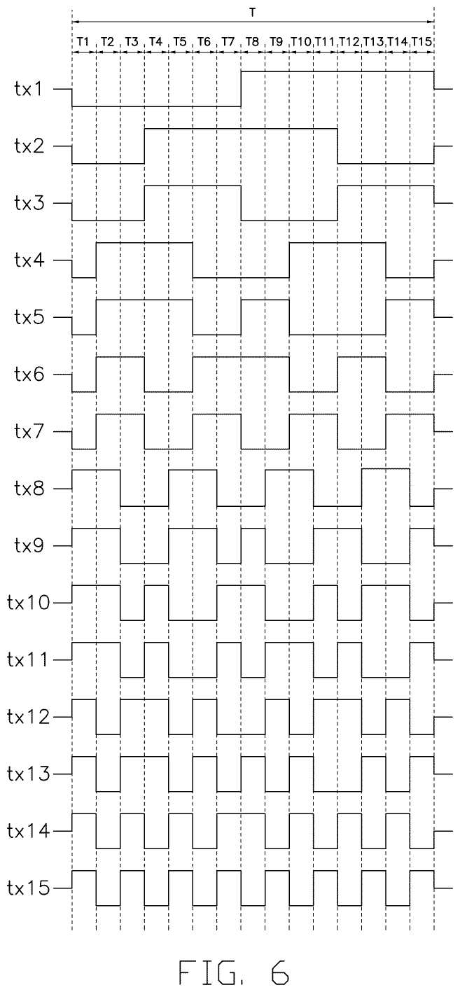

Referring to FIG. 5 and FIG. 6, in another embodiment of the present disclosure, the driving code matrix is related to the Walsh Hadamard matrix, the driving signals are sent to the driving electrodes TX1, TX2 . . . . TX2ⁿ-2 and TX2ⁿ-1 based on the driving code matrix shown in FIG. 5 and output timing characteristics shown in FIG. 6, the sensing electrodes RX1, RX2 . . . . RX2ⁿ-2 and RX2ⁿ-1 can generate a corresponding sensing code matrix, and the touch positions can be obtained.

The touch control method of the present disclosure modifies the traditional Hadamard matrix or Walsh Hadamard matrix by removing the row including codes 1 only and the column including cedes 1 only, which changes the order of the traditional Hadamard matrix or Walsh Hadamard matrix from 2ⁿ to 2ⁿ-1, thereby a new driving code matrix (that is, the driving code matrix shown in FIG. 3 or FIG. 5) of order 2ⁿ-1 is obtained. The arithmetic sum of each column of codes in the driving code matrix of the present disclosure is 1. Based on the driving code matrix, the driving signals are simultaneously output to the driving electrodes TX1, TX2 . . . . TX2ⁿ-2 and TX2ⁿ-1, the sensing electrodes RX1, RX2 . . . . RX2ⁿ-2 and RX2ⁿ-1 receives the sensing signals. Each sensing electrode is used to receive the accumulated sum of multiple sensing signals on one column of touch nodes corresponding to the sensing electrode. The ADC is used to sample, hold, and quantify the sensing signals. According to the ADC sampling principle, all sensing electrodes have a same sampling standard since each column of codes in the driving code matrix of the present disclosure have the same arithmetic sum(1). Furthermore, the total signal received by each sensing electrode has low and stable amplitude, making less sampling distortion and improving the signal-to-noise ratio of the touch panel 100.

Referring to FIG. 1 again, the present embodiment also provides a touch control circuit 20 including an electrically connected memory 21 storing computer programs and a processor 22. In response to processor 22 executing the computer programs, the touch panel 100 is used to implement the steps of the touch control method as described above, acquiring the touch positions and subsequently initiating associated functionalities of a smart device (such as phones and displays) including the touch panel 100.

The embodiments of the present disclosure provide a computer-readable storage medium that stores the computer program that, when executed by the processor, performs the steps in the above-described touch control method.

The above-described touch control method may be implemented and commercially exploited as a standalone product by being stored on a computer-readable storage medium. In accordance with this disclosure, the complete or partial processes of the aforementioned method embodiments may alternatively be executed through computer program instructions directing associated hardware components. Said computer program may be stored on a computer-readable storage medium, wherein execution of the program by a processor facilitates implementation of all steps within the described method embodiments. The computer program comprises program code, which may exist in source code form, object code form, executable file format, or intermediate representations thereof. Computer-readable storage media as claimed may encompass any tangible or intangible medium capable of bearing said program code, including but not limited to: recording media (e.g., USB flash drives, portable hard drives, magnetic disks, optical discs), computer memory devices (e.g., Read-Only Memory [ROM], Random Access Memory [RAM]), electrical carrier signals, telecommunications signals, and software distribution media.

As used herein, the term “processor” refers to a Central Processing Unit (CPU) or alternative processing units including, without limitation: general-purpose processors, Digital Signal Processors (DSPs), Application-Specific Integrated Circuits (ASICs), Field-Programmable Gate Arrays (FPGAs), other programmable logic devices, discrete gate or transistor logic components, and discrete hardware modules. General-purpose processors may comprise microprocessors or conventional processor architectures. The processor operates as the control center of a sample processing system/device, coordinating system components through interconnected interfaces and circuitry.

The memory is used to store computer programs and/or functional modules. Through execution of these memory-resident programs/modules and associated data retrieval, the processor enables the sample processing system/device to perform its designated functions. The memory architecture primarily includes a program storage region housing system software (e.g., operating systems) and application programs (e.g., audio/video processing functions) and a data storage region for operational parameters and user data. The memory incorporate high-speed volatile memory (e.g., RAM) and non-volatile storage including: internal/external hard drives, embedded memory, removable media (Smart Media Cards [SMC], Secure Digital [SD] cards, Flash cards), disk-based storage devices, flash memory devices, and other volatile/non-volatile solid-state memory solutions.

Finally, it should be noted that the above embodiments are only used to illustrate the technical solution of the present application and not to limit the present application. Although the present application has been described in detail with reference to preferred embodiments, one ordinary skill in the art should understand that the technical solution of the present application can be modified or equivalent replaced without departing from the spirit and scope of the technical solution of the present application.

What is claimed is:

1. A touch control method applied to a touch panel comprising a plurality of driving electrodes and a plurality of sensing electrodes intersect to form a plurality of touch nodes, the touch control method comprising:
receiving a driving code matrix of 2ⁿ-1 order comprising a plurality of codes corresponding to the plurality of touch nodes, n is a positive integer greater than 1;
sending a plurality of driving signals to the plurality of driving electrodes simultaneously according to the driving code matrix; and
receiving a sensing code matrix generated by the plurality of sensing electrodes based on the plurality of driving signals, wherein the sensing code matrix is configured to obtain a touch position.

2. The touch control method according to claim 1, wherein each column of the driving code matrix comprises a plurality of codes 1 and a plurality of codes −1, each of the plurality of codes 1 represents sending a positive driving signal to a corresponding touch driving electrode, and each of the plurality of codes −1 represents sending a negative driving signal to a corresponding touch driving electrode.

3. The touch control method according to claim 2, wherein the sending a plurality of driving signals to the plurality of driving electrodes simultaneously comprises:
sending a plurality of positive driving signals to partial of the plurality of driving electrodes simultaneously and sending a plurality of negative driving signals to the remaining driving electrodes simultaneously.

4. The touch control method according to claim 2, wherein each column of codes in the driving code matrix has a same arithmetic sum.

5. The touch control method according to claim 4, wherein each column of codes in the driving code matrix has the arithmetic sum of 1.

6. The touch control method according to claim 1, after the receiving a sensing code matrix generated by the plurality of sensing electrodes based on the plurality of driving signals, the touch control method further comprises:
multiplying the sensing code matrix by a preset demodulation matrix to obtain a capacitance matrix; and
recognizing the touch position according to the capacitance matrix.

7. The touch control method according to claim 6, wherein the preset demodulation matrix is obtained by changing all codes −1 of the sensing code matrix into 0.

8. A touch control circuit comprising a memory storing a computer program and a processor connected to the memory, a touch control method being performed when the computer program being executed by the processor, the touch control method comprising:
receiving a driving code matrix of 2ⁿ-1 order comprising a plurality of codes corresponding to the plurality of touch nodes, n is a positive integer greater than 1;
sending a plurality of driving signals to the plurality of driving electrodes simultaneously according to the driving code matrix; and
receiving a sensing code matrix generated by the plurality of sensing electrodes based on the plurality of driving signals, wherein the sensing code matrix is configured to obtain a touch position.

9. A touch panel comprising:
a plurality of driving electrodes;
a plurality of sensing electrodes intersecting the plurality of driving electrodes to form a plurality of touch nodes; and
a touch control circuit comprising a memory storing a computer program and a processor connected to the memory, a touch control method being performed when the computer program being executed by the processor, the touch control method comprising:
receiving a driving code matrix of 2ⁿ-1 order comprising a plurality of codes corresponding to the plurality of touch nodes, n is a positive integer greater than 1;
sending a plurality of driving signals to the plurality of driving electrodes simultaneously according to the driving code matrix; and
receiving a sensing code matrix generated by the plurality of sensing electrodes based on the plurality of driving signals, wherein the sensing code matrix is configured to obtain a touch position.

10. The touch panel according to claim 9, wherein each column of the driving code matrix comprises a plurality of codes 1 and codes −1, each of the plurality of codes 1 represents sending a positive driving signal to a corresponding touch driving electrode, and each of the plurality of codes −1 represents sending a negative driving signal to a corresponding touch driving electrode.

11. The touch panel according to claim 10, wherein the sending a plurality of driving signals to the plurality of driving electrodes simultaneously comprises:
sending a plurality of positive driving signals to partial of the plurality of driving electrodes simultaneously and sending a plurality of negative driving signals to the remaining driving electrodes simultaneously.

12. The touch panel according to claim 10, wherein each column of codes in the driving code matrix has a same arithmetic sum.

13. The touch panel according to claim 12, wherein each column of codes in the driving code matrix has the arithmetic sum of 1.

14. The touch panel according to claim 9, after the receiving a sensing code matrix generated by the plurality of sensing electrodes based on the plurality of driving signals, the touch control method further comprises:
multiplying the sensing code matrix by a preset demodulation matrix to obtain a capacitance matrix; and
recognizing the touch position according to the capacitance matrix.

15. The touch control method according to claim 14, wherein the preset demodulation matrix is obtained by changing all codes −1 of the sensing code matrix into 0.
